(19) United States
(12) Patent Application Publication
(10) Pub. No.: US 2010/0129206 A1
(43) Pub. Date: May 27, 2010

(54) IMPULSE TURBINE

(75) Inventors: Gerhard Pfeffer, Nuernberg (DE); Albert Regensburger, Nürnberg (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AKTIENGESELLSCHAFT, Muenchen (DE)

(21) Appl. No.: 12/596,017

(22) PCT Filed: Apr. 15, 2008
(86) PCT No.: PCT/EP2008/054561

§ 371 Date: Oct. 15, 2009

(30) Foreign Application Priority Data
Apr. 17, 2007 (DE) 10 2007 018 063.4

(51) Int. Cl. F01D 11/00; F16J 15/32

(52) U.S. Cl. 415/173.7

(57) ABSTRACT

An impulse turbine is provided. By providing brush seals on the free ends of the guide vanes, which form an acute angle with the radial line in relation to the radial line in the direction of rotation of the rotor, leakage losses may be reduced and the rotor friction between the guide surfaces may be reduced.

The present invention relates to an impulse turbine.

By comparison with the reaction principle of the reaction turbine, the principle of the impulse turbine has an efficiency advantage. However, the thermodynamics and flow technology of an impulse turbine necessitate a larger shaft diameter compared to reaction turbines. Built in between the rotating rotor and the stationary housing there are labyrinth seals over the guide vanes and impeller blades, to seal the steam channel. The radial play of the seals is approximately the same for impulse and reaction turbines. The minimum radial play of the seals is determined by the movement of the rotor in its bearings and by the shaft vibrations. The play must be larger than the maximum rotor movement, in order to avoid any contact and consequent damage.

However, the larger shaft diameter of the impulse turbine results in an annular gap with a larger area, and hence a greater leakage flow.

In order to minimize these losses, the diameter of the rotor is reduced in the region of the guide vanes, and built on over each set of stationary guide vanes is a guide vane base, the outer surface of which lies opposite the rotor, and at a distance from it defined appropriately for the required radial play. In this way, the circumference of the gap and hence its area is substantially reduced. The resulting disk-shaped mountings for the impeller blades on the shaft are referred to as “wheel disks”. However, the frictional losses at the wheel, which arise between the guide vane bases and the wheel disks have a disadvantageous effect. The efficiency advantage of the impeller turbine over the reaction turbine is completely eliminated by the high leakage losses, or the wheel friction between the guide vane bases and the impeller blades.

In addition, this form of construction brings substantial problems in respect of stability of the guide vane bases, and a substantial additional cost due to the construction effort.

It is the object of the present invention to specify an impulse turbine in which the leakage losses are minimized and at the same time the wheel friction between the guide vane base and the impeller blades is substantially reduced.

This object is achieved in accordance with the invention in that the inventive impulse turbine is provided with brush seals, at the free ends of the guide vanes, which relative to the radial line in the direction of rotation of the rotor shaft form an acute angle with the radial line.

Unlike labyrinth seals made of stiff sheet material, the brushes consist of numerous fine wires. When subject to a pressure difference, the wires lie firmly against one another and form a sealed lattice, impermeable to steam. As with labyrinth plates, a leakage flow can only occur through the radial gap between the impeller and the seal. Oblique installation of the wires relative to the radials makes the seal tolerant to contact. If a radial movement of the impeller results in contact with the seal, their oblique positioning means that the brush wires bend aside. After the contact, the wires swing back into their initial position. The contact does not result in any damage. Consequently, the minimum radial gap can be reduced to less than the maximum play due to impeller movements.

The small radial gap for the brush seal enables the large leakage losses due to the guide vane base flow to be substantially reduced. The form of construction using the guide vane base and wheel disk can be eliminated. The construction of the guide vanes and impeller blades is identical to that of the cost-effective reaction turbine.

An expedient development of the inventive impulse turbine is characterized by the fact that brush seals are provided both at the front and at the back, relative to the direction of flow, on the free ends of the guide vanes. This further reduces the presence of a leakage flow.

Another expedient development is characterized by the fact that a baffle plate is arranged between the brush seals. With the help of the baffle plate, a further reduction in the leakage flow is possible.

An exemplary embodiment of an impulse turbine in accordance with the present invention is explained below in more detail by reference to the attached drawings, in which;

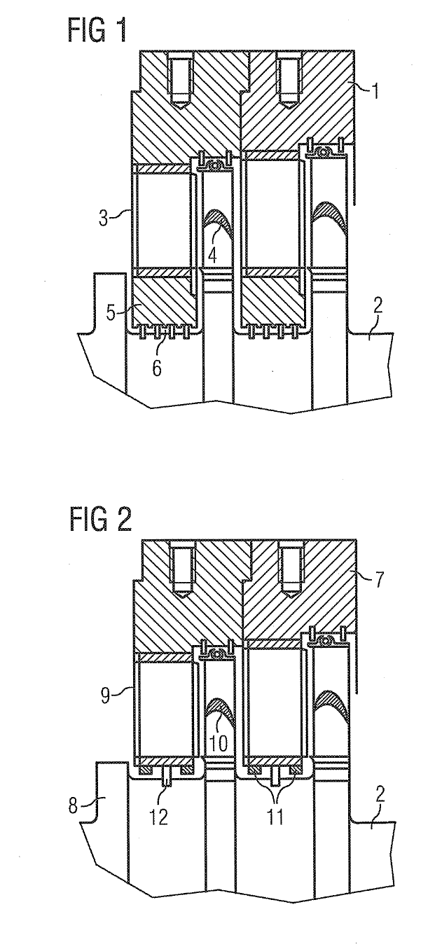

FIG. 1 shows a partial section through a conventional impulse turbine, and

FIG. 2 shows a partial section through an impulse turbine in accordance with the present invention.

FIG. 1 shows parts of the housing 1 with the guide vanes 3 which are attached to it. The impeller blades 4 are attached to the rotor shaft 2 and are sealed against the housing 1.

On the free end of each guide vane 3 is provided a so-called guide vane base 5, which engages in a recess in the rotor shaft 2. Between the free end of the guide vane base 5 and the rotor shaft 2, labyrinth seals 6 are provided.

It can be clearly seen from the figure that additional frictional losses arise between the guide vane base 5 and the wheel disk.

FIG. 2 shows a partial section through an impulse turbine in accordance with the present invention. The guide vanes 9 are attached to the housing 7. The impeller blades 10 are rigidly joined to the rotor shaft 8.

In the case of the impulse turbine in accordance with the invention, the thickness of the shaft is not reduced in the region of the guide vanes. Two brush seals 11 are provided between the rotor shaft 8 and the free end of the guide vane 9.

As already mentioned in the introduction, the brushes consist of numerous fine wires. When subject to a pressure difference, the wires lie firmly against one another and form a sealed lattice, impermeable to steam. Oblique installation of the wires relative to the radial makes the seal tolerant to contact. The small radial gap of the brush seals, which is generally 5 to 7/100, by contrast with the radial gap of a 3/10 for a labyrinth seal, enables the large leakage losses to be substantially reduced.

A further reduction in the leakage losses results from the installation of a baffle plate 12 between the two brush seals.

1.-3. (canceled)

4. An impulse turbine, comprising:
a plurality of brush seals provided at a plurality of free ends of the plurality of guide vanes,
wherein the plurality of brush seals, relative to a radial line in a direction of rotation of a rotor shaft, form an acute angle with the radial line.

5. The impulse turbine as claimed in claim 4, wherein the plurality of brush seals are provided both at a front and at a back on the free ends of the plurality of guide vanes, relative to a direction of flow.

6. The impulse turbine as claimed in claim 5, wherein a baffle plate is arranged between the plurality of brush seals.

7. The impulse turbine as claimed in claim 4, wherein the plurality of brush seals comprise a plurality of fine wires.

8. The impulse turbine as claimed in claim 4,
wherein when subject to a pressure difference, the plurality of brush seals lie firmly against one another and form a sealed lattice, and
wherein the sealed lattice is impermeable to steam.
